(19) United States
(12) Patent Application Publication
(10) Pub. No.: US 2006/0134328 A1
(43) Pub. Date: Jun. 22, 2006

(54) Binding systems using ink jet printing technology

(75) Inventors: Nancy Jia, Webster, NY (US); Joel Kubby, Rochester, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/013,689

(22) Filed: Dec. 17, 2004

(51) Int. Cl. B41J 2/015; B41J 2/04; B05D 5/10; B65C 11/04

(52) U.S. Cl. 427/207.1; 347/21; 347/54; 156/578

(57) ABSTRACT

Systems, methods and apparatus use ink jet printer technology for binding applications by using at least some ink fluid ejectors as glue fluid ejectors. For example, in a printing device including recording head cartridges and reservoirs dedicated to each of the colors (Y, M, C, K), a user could replace the reservoirs storing ink with reservoirs storing glue. If a user desires to eject two-component glue, two reservoirs could be filled with one component of the glue and the other two reservoirs could be filled with the second component of the glue. Alternatively, a user could add additional reservoirs, channels, and corresponding ejectors to the system. After making the color images with marking components, the glue ejectors could be used for binding. Because exemplary embodiments use marking technology, such as ink jet printer technology, embodiments provide precise positioning, high metering and accurate delivery of a three pico-liter size glue drop. All components of the glue should have similar viscosity and surface tension properties, along with as many other similar properties, to the other fluid used in the fluid ejectors as possible.

### BACKGROUND

1. Field of Disclosure

Systems, methods and apparatus for binding that have the ability to precisely place and locate at least one fluid, i.e., a fluid used as a glue or an adhesive, ejected by at least one fluid ejector on a substrate and using that fluid as part of a process to bind a substrate.

2. Description of Related Art

Conventional binding systems use large adhesive supply, storage and application units (with large glue ejection nozzles) or glue gun technology to bind one substrate to another substrate.

For example, TWDynatec™ provides products including adhesive supply units, adhesive feeders, adhesive drum unloaders, automatic/manual applicators, nozzles and adhesive pattern controllers. TWDynatec™ systems feed adhesive from a supply/storage unit through a feeder tube from a glue tank to a nozzle. The adhesive is ejected through the nozzle.

Systems are known in the art for binding a book. U.S. Pat. No. 6,142,721 to Marsh, the disclosure of which is incorporated herein by reference in its entirety, discloses an apparatus and method for binding a book. In Marsh, a book is printed by a book publishing system. After printing, the book block and book cover are conveyed to a book binding system. An adhesive strip is applied to the inner surface of the center portion of the book cover. The book pages are inserted into the book cover and compressed with the book cover. A horn then applies ultrasonic energy to the adhesive sufficient to melt the adhesive.

A glue gun is a hand-held device by which a user can manually apply adhesive to a substrate. A glue gun includes, generally, a tube filled with an adhesive, such as glue, a nozzle through which the glue is ejected, and a device for applying pressure to the tube. Upon applying pressure to the tube, glue is ejected from the nozzle of the glue gun. PAM® Fastening Technology Inc. provides hand-held hot-melt glue guns.

Printer fluid ejector systems, such as continuous stream jet printing and drop-on-demand ink jet printers, have fluid ejectors from which ink droplets are ejected toward a substrate. U.S. Pat. No. 5,672,413 to Taylor, the disclosure of which is incorporated herein by reference in its entirety, discloses two categories of practices of placing an image on a substrate. One category, direct imaging, prints an image directly on the final substrate, e.g., typical ink jet printing, and a second category, transfer imaging, prints an image onto an intermediate substrate and then transfers the image onto a final substrate.

In drop-on-demand printers, including piezoelectric, acoustic, hot-melt solid ink and/or phase change wax-based or thermal ink jet printers, the ink jet printer has a plurality of channels connecting an array of fluid ejectors to an ink storage reservoir. Power pulses cause the small ink droplets to be expelled on-demand from the fluid ejectors located at the end of the channels with controlled, precise accuracy.

When the fluid ejector is part of an ink jet printhead, the fluid ejector may be incorporated into, for example, a carriage-type printer, a partial width array-type printer, or a page-width type printer. The carriage-type printer typically has a relatively small reciprocating printhead containing the ink channels and fluid ejectors and is attached to a liquid ink storage reservoir, such as an ink supply cartridge. In a combined printhead and cartridge assembly, the assembly is attached to a carriage that is reciprocated to print one swath of information at a time on a sheet of paper. Each swath of printed information may be equal to the length of a column of fluid ejectors. In a page-width type printer, the ink jet fluid ejector arrays extend the length of the width capable of being printed. The fluid ejectors are connected to channels that are connected to an ink reservoir. The ink supply may be hot-melt solid ink or liquid ink.

Printing systems step the sheet of paper a distance generally equal to or less than the height of the swath to be printed, so that the next printed swath is contiguous or overlaps with the previously printed swath. When there is no information to print in large blocks, the sheet may be stepped a larger amount. This procedure is repeated until the entire image is printed.

### SUMMARY

The methods and apparatus disclosed use ink jet printer technology for glue ejection and binding applications by replacing ink fluid in at least some of the channels with glue. The methods and apparatus disclosed may also use ink printing technology for glue printing. Throughout the specification the term “glue” will be used when referring to all types of glue, e.g., hot-melt or phase change glue, ultraviolet (UV) curable glue, multiple-component glue, liquid glue, epoxies, and/or other adhesive fluids, used in exemplary embodiments; however, any type of fluid capable of binding could be used in the exemplary embodiments. Throughout the specification, references to ink jet printer technology are intended to include printer technology capable of printing with liquid ink or phase change ink (e.g., hot melt ink).

Generally, in exemplary embodiments, ink, i.e., hot-melt ink and/or liquid ink, used in ink jet printer technology is replaced with glue. Conventional ink jet printers, such as a Xerox Phaser 850, or Xerox Phaser 860 printer can be used to mark a substrate with glue, much the same as the printers are used for marking a substrate with ink or toner.

Exemplary embodiments use apparatuses, systems, processes and methods of ink jet printer technology that were, at least in part, dedicated to ejecting ink and creating an image on a substrate, to eject glue. As such, the ink jet printer technology can be used to create the same precision and control of an image and/or pattern on a receiving substrate using glue as ink jet printer technology could create using conventional ink.

Because the glue replaces the ink in the printer technology, the advantages of the printer technology can be extended to binding system technology. For example, exemplary embodiments provide, generally, precise positioning, high metering and accurate delivery of a few pico-liter size glue drop to an approximately 100 pico-liter size glue drop on a receiving substrate. The prior art cannot provide such precise positioning and high metering of glue ejection offered by exemplary embodiments. Instead, generally, the prior art is prone to depositing a large amount of glue outside of intended placement areas, resulting in glue wasting and uncontrolled glue placement. In exemplary embodiments, on the other hand, only those areas of the substrate intended to be bonded receive glue.

Other advantages of ink jet printer technology are also extended to other technologies such as binding systems, packaging, customized mail, decoration, art systems, three-dimensional glue printing, and systems for the assembly of intricate parts technology. For example, glue marking resolution and glue ejection directionality, (e.g., ejection and control) can be used to improve these technologies. Similarly, the advantages of these technologies can be extended to ink jet printer technology. For example, exemplary embodiments provide, generally, systems and methods, i.e., an on-demand publishing system, for achieving both printing and binding of a book or magazine, using the same marking technology.

Thus, because exemplary embodiments use ink jet printer technology, exemplary embodiments provide precise positioning and metering of ejected glue only in intended areas on a substrate. Moreover, because exemplary embodiments provide a binding system that can be used for both printing and binding, an advantage is obtained over the prior art in the quick delivery of a printed and bound substrate, i.e., a book or magazine.

In various exemplary embodiments, a binding system includes an array of fluid ejectors and at least one fluid supply reservoir connected by a fluid supply channel; a glue composition that has generally the same viscosity and surface tension as a fluid other than glue at the fluid ejector operating temperature; wherein the fluid ejectors, fluid supply channel and the fluid supply reservoir are compatible for use with both the glue and the fluid other than glue; and the fluid ejectors have a resolution of at least 75 dots per inch and eject the glue with a precisely controlled pattern.

In various exemplary embodiments, the binding system further includes an array of fluid ejectors connected to at least one fluid supply reservoir by a fluid supply channel; and the fluid ejectors eject ink or toner.

In various exemplary embodiments, the binding system is capable of delivering a three pico-liter size glue drop on a substrate.

In various exemplary embodiments, the binding system preferably deliveries between a 10 and 40 pico-liter size glue drop on a substrate.

In various exemplary embodiments, the glue is solid at room temperature.

In various exemplary embodiments, the glue is liquid at room temperature.

In various exemplary embodiments, a finishing system includes the binding system.

In various exemplary embodiments, an on-demand publishing system includes the binding system.

In various exemplary embodiments, a printhead is used for both printing images and binding/book finishing. The printhead may have multiple arrays of fluid ejectors dedicated to ejecting ink and at least one array of fluid ejectors dedicated to ejecting glue.

In various exemplary embodiments, a method of using the binding system includes inserting a liquid glue supply cartridge or hot-melt solid glue supply stick in at least one of the fluid supply reservoirs; and ejecting glue from at least one of the fluid ejectors in a precisely controlled pattern.

In various exemplary embodiments, a method of using the binding system, further includes inserting a marking fluid supply cartridge in another fluid's supply reservoir; and ejecting the marking fluid.

In various exemplary embodiments, a glue for use with the binding system has a viscosity between 3 cp and 60 cp and a surface tension of approximately 15 to 30 dyne-cm.

In various exemplary embodiments, a glue for use with the binding system includes a first component and a second component. The first component may be a resin solution and the second component may be an activator solution that initiates the adhesive property of the glue once the resin solution and the activator solution are mixed.

In various exemplary embodiments, the components of the glue are liquid at room temperature as well as at an elevated temperature.

In various exemplary embodiments, either the glue or the components of the glue are solid at room temperature and liquid at the printer operating temperature.

In various exemplary embodiments, a system that ejects phase-change (e.g. hot melt glue) or UV curable glue may have an operating temperature between 80° C. to 140° C.

In various exemplary embodiments, a method of placing the glue on a substrate, includes placing the droplets of the first component on a substrate; subsequently, placing the droplets of second component on top of or in a close proximity to the droplets of the droplets of the first component on the substrate such that mixing of the two components may occur on the substrate.

In various exemplary embodiments, multiple components of the glue may be pre-mixed prior to droplets being placed on a substrate.

Other objects, advantages and features will become apparent in the following detailed description taken in conjunction with the attached drawings, which disclose exemplary embodiments.

### BRIEF DESCRIPTION OF THE DRAWINGS

Exemplary embodiments will be described with reference to the following drawings in which like reference numerals refer to like elements and wherein:

FIG. 1 illustrates one exemplary embodiment of a carriage-type liquid printer system;

FIG. 2 illustrates one exemplary embodiment of a perspective view of a carriage-type liquid printer system having replaceable supply tanks;

FIG. 3 illustrates a partially exploded perspective view of one exemplary embodiment of an ink jet cartridge used in the printer shown in FIG. 2;

FIG. 4 illustrates an exemplary embodiment of a relationship between the fluid ejector arrays, a fluid pipe connector and a fluid supply tank;

FIG. 5A illustrates an exemplary embodiment of a relationship between the fluid ejector arrays, fluid pipe connectors and fluid supply tanks;

FIG. 5B illustrates an alternative exemplary embodiment of a relationship between the fluid ejector arrays, fluid pipe connectors and fluid supply tanks;

FIG. 6 illustrates an exemplary embodiment of a relationship between the fluid ejector arrays, fluid pipe connectors and fluid supply tanks;

FIG. 7 illustrates an exemplary embodiment of a page-width array;

FIG. 8 illustrates one exemplary embodiment of a perspective view of a solid marker system;

FIG. 9 illustrates one exemplary embodiment of a perspective view of a hot-melt solid ink stick;

FIG. 10 illustrates one exemplary embodiment of a partial top perspective view of the solid marker system shown in FIG. 8 with an access cover portion open and showing the hot-melt solid ink stick shown in FIG. 9 in a position to be loaded into the solid marker system;

FIG. 11 is a block diagram illustrating one exemplary embodiment of an on-demand publishing system using a binding system;

FIG. 12 illustrates one exemplary embodiment of an on-demand publishing system using a printing system in line with a binding system;

FIG. 13A is a cross sectional view of one exemplary embodiment of an on-demand publishing system taken along line A-A of FIG. 12 illustrating a printer which prints a book's cover and deposits the book's cover on a bed, and a transport conveyor system which rotates the book's cover and transports the book's cover to a next station;

FIG. 13B is a cross sectional view of one exemplary embodiment of an on-demand publishing system taken along line B-B of FIG. 12 illustrating a printer which prints a book's pages and deposits the book's pages on a bed, and a transport conveyor system which rotates the book's pages and transports the book's pages to a next station;

FIG. 14 is one exemplary embodiment illustrating a view of fluid ejectors located on a printhead which eject fluid drops onto a receiving substrate;

FIG. 15 is a plan view of an inner face of a book's cover illustrating an exemplary embodiment of areas of a book's cover and a location of glue within the cover;

FIG. 16 illustrates one exemplary embodiment of a book's cover, pages, and glue in a position to be bound between pressing rollers within a binding system;

FIG. 17 illustrates one exemplary embodiment of a book's cover, pages, and glue bound between pressing rollers within a binding system; and

FIG. 18 illustrates one exemplary embodiment of a block diagram of a control system for controlling a binding system.

### DETAILED DESCRIPTION OF PREFERRED EMBODIMENTS

The following detailed description of various exemplary embodiments of binding systems using fluid ejection systems may refer to one specific type of fluid ejection system, an ink jet printer capable of ejecting either liquid or phase-change (e.g., hot-melt ink), for sake of clarity and familiarity. However, it should be appreciated that the principles as outlined and/or discussed throughout the specification, can be equally applied to any known or later developed fluid ejection system, beyond the ink jet printer specifically discussed herein.

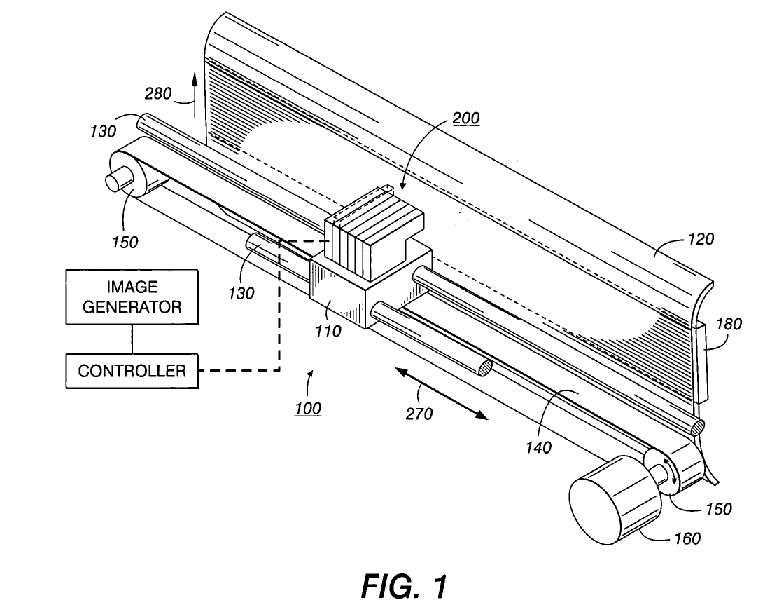

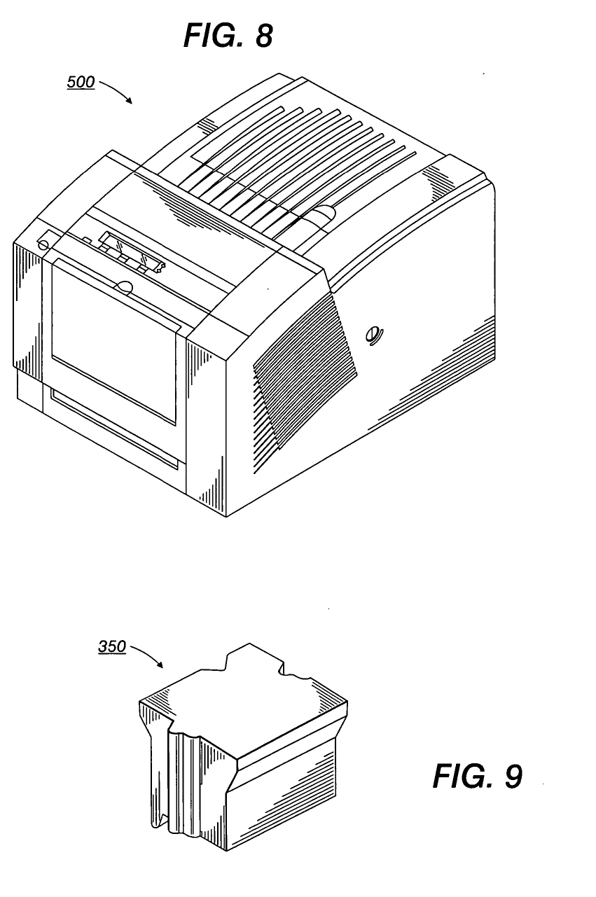

For simplicity and clarification, the operating principles and design factors of various exemplary embodiments of the systems, methods and apparatus are explained, in part, with reference to a carriage-type liquid marker system 100, as shown in FIG. 1, and a solid marker printer 500, as shown in FIG. 8. The basic explanations of the operation of the liquid marker system 100 and solid marker system 500 is applicable for the understanding and design of a fluid ejection system. Although the systems, methods and apparatus are described in conjunction with such markers using ink jet technology, the systems, methods, and apparatus can be used with any other known or later developed fluid ejection system. In either a liquid marker system 100 or a solid marker printer system 500, one or more sets of fluid reservoirs, fluid channels, and arrays of fluid nozzles are used to eject glue, rather than ink. Alternatively, one or multiple sets of additional fluid reservoirs, fluid channels, and arrays of fluid nozzles may be used by the system to subsequently eject glue after ejecting a marking fluid.

FIG. 1 shows a carriage-type ink jet printing device 100. Recording heads/cartridges 200 for delivering marking fluids, such as ink, and/or binding fluids, such as glue compositions, are mounted in cartridge holders provided on a carriage/head portion 110. The carriage reciprocally moves across the receiving substrate 120 along guide rails 130. The carriage may be reciprocally moved by a cable 140 and a pair of pulleys 150 powered by a reversible motor 160 under the control of the printer controller. Each cartridge holder includes appropriate mechanical, electrical and fluid couplings so that selected fluid drivers can be activated in response to a suitable driving signal from the controller to expel fluid from the cartridges onto a recording substrate 120 supported upon a platen 180.

The controller receives signals representing an image from an image generator. Image generators include a scanner or digitizer that scans data and generates signals, or a computer and associated software and/or user interfaces that generate digital image signals.

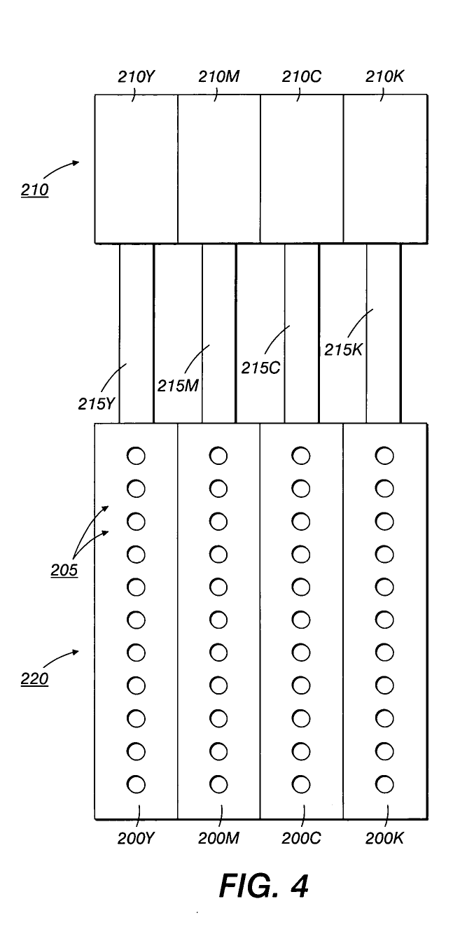

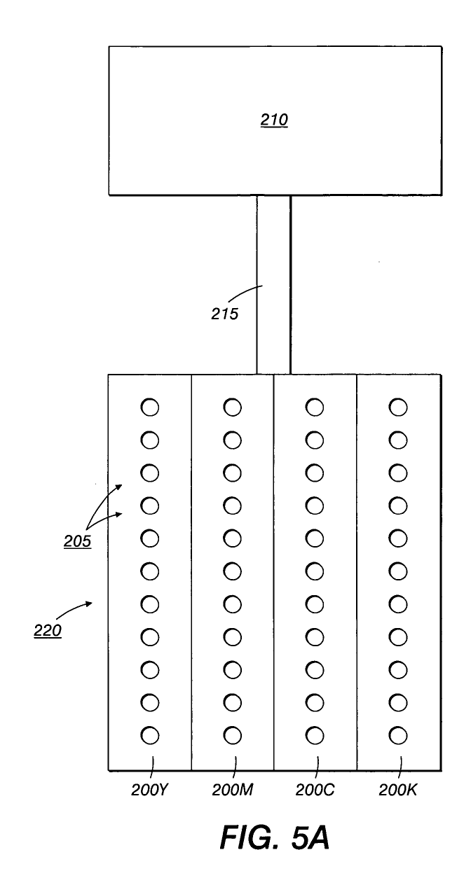

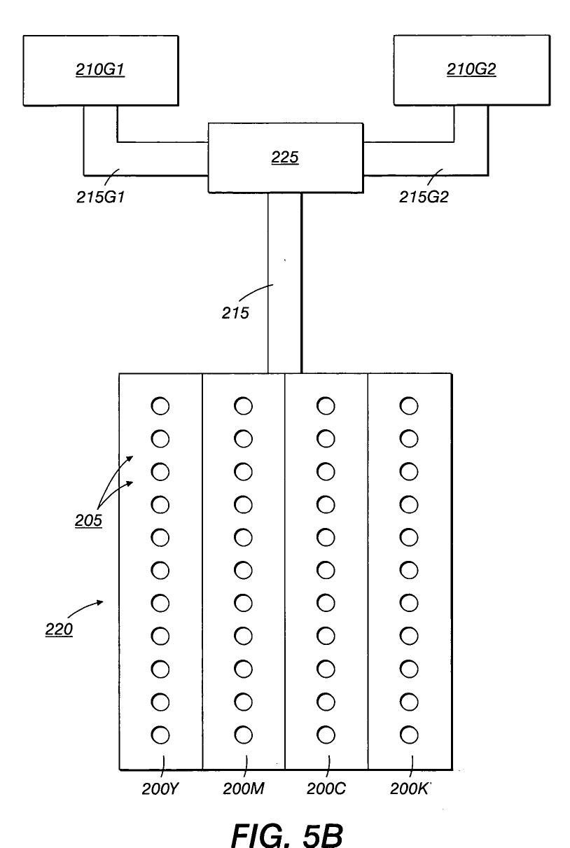

As shown in FIGS. 4 and 5, each cartridge 200 is provided with an array of aligned fluid ejectors 205. The group of cartridges, including the array of fluid ejectors, form a printhead 220. The fluid ejectors 205 can be of any size and spacing depending on the desired resolution of the printing device 100. For example, if a resolution of 300 spots per inch is preferred, the neighboring fluid ejectors would have a center to center spacing of approximately 84 microns. The fluid ejectors 205 are closely spaced apart from one another at a defined resolution, such as 75, 300, 600, 900 or 1200 dpi (dots per inch) or higher. The size of the fluid ejector 205 determines the size of the droplets of fluid (glue or ink) that the fluid ejector ejects. The fluid ejectors 205 are connected to a storage reservoir, such as a cartridge 200 by supply channels 215 as is known in the art. The cartridge 200 includes ejection devices/fluid drivers (not shown) that apply energy to eject fluid (glue or ink) droplets from the fluid ejectors 205 toward a receiving substrate 120. Fluid ejectors 205 may include color ink ejectors and black ink ejectors. Color ink fluid ejectors are, generally, vertically aligned so that a second ink drop can be deposited on top of a first ink drop before the first ink drop has set or solidified. Black ink ejectors are, generally, horizontally offset to help prevent the mixing of black ink with colored inks. At least one array of the fluid ejectors has its fluid substituted with glue to achieve a binding functionality.

Ejection devices apply energy pulses to cause the fluid to be expelled on-demand from the fluid ejectors. In thermal printers a fluid drop is ejected from a fluid ejector by an ejection device forming a vapor bubble within a fluid-bearing channel. The bubble may be formed by a heater, such as a heating resistor, located on a surface of the supply channel. In a piezo printer the recording heads 200 may include a piezo electric element and a pressure chamber. The piezo electric element is used for pressurizing the fluid in a fluid bearing pressure chamber. Liquid glue or liquefied hot-melt glue is ejected from the fluid ejectors when the piezo electric element applies energy to a fluid bearing pressure chamber.

In the exemplary embodiment shown in FIG. 1, fluid droplets are ejected horizontally from the recording heads 200 toward the receiving substrate 120. However, fluid droplets may also be propelled vertically or diagonally. Thus, although the systems, methods and apparatus of this exemplary embodiment are described with reference to droplets being fired horizontally, the systems and methods can include droplets being fired vertically or diagonally.

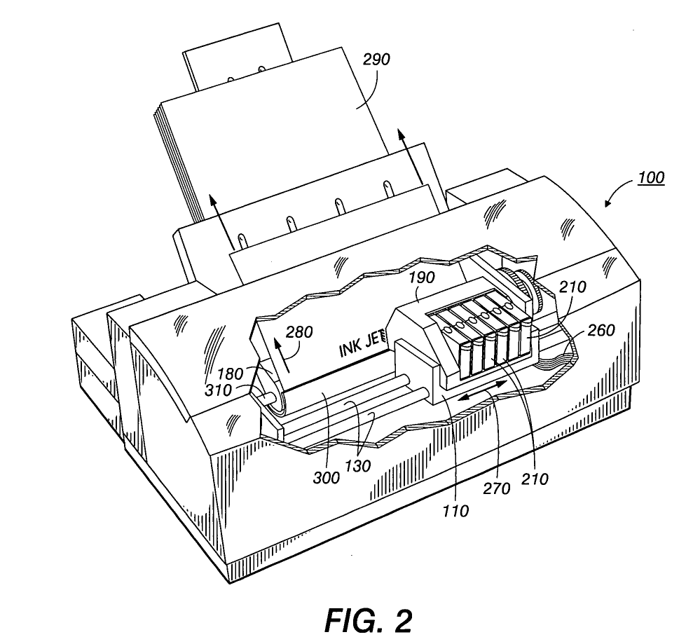

FIG. 2 illustrates a view of a multicolor, single printhead ink jet printer 100. In the exemplary embodiment, the printer includes six replaceable fluid supply tanks 210 mounted in a removable cartridge 190. The fluid supply tanks 210 supply marking fluids, such as ink, or binding fluids such as glue compositions. The removable cartridge 190 is mounted on a carriage 110.

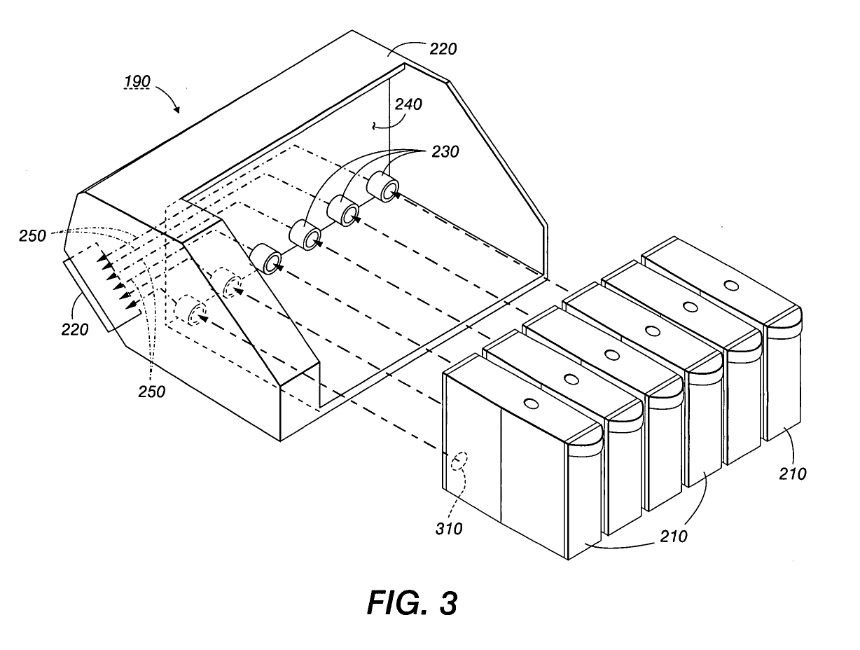

As shown in FIG. 3, the cartridge 190 comprises a housing 220 having an integral printhead 220 and pipe connectors 230 which protrude from a wall 240 of the cartridge for insertion into the fluid tanks 210 when the fluid tanks are mounted in the cartridge housing. Fluid flow paths, represented by dashed lines 250, in the cartridge housing, connect each of the pipe connectors with the separate inlets of the printhead. The cartridge, which comprises the replaceable fluid supply tanks that store fluid and supply fluid to the printhead 220, include an interfacing printed circuit board (not shown) that is connected to the printer controller by a ribbon cable 260 through which electric signals are selectively applied to the printhead to selectively eject fluid droplets from the printhead fluid ejectors 205. The printhead 220 contains a plurality of fluid channels which carry fluid from each of the fluid tanks to respective groups of printhead fluid ejectors.

As shown in FIGS. 1 and 2, the fluid printer prints by reciprocating the carriage 110 back and forth along the guide rails 130 in the direction of arrow 270. As the printhead 220 reciprocates back and forth across a recording substrate 120, such as a sheet of paper, a plastic film, a metal foil or a transfer drum, fluid droplets are ejected from selected fluid ejectors toward the substrate. The fluid ejectors are generally arranged in a linear array perpendicular to the reciprocating direction shown by arrow 270. During each pass of the carriage 110, the recording substrate 120 is held in a stationary position. At the end of each pass, the recording substrate is stepped in the direction of arrow 280.

In the exemplary embodiment shown in FIGS. 1 and 2, a sheet is fed from a stack 290 of paper in a tray through the printer along a path defined by platen 180 and guide 300. The sheet is driven along the path by a transport roller 310 as is understood by those skilled in the art. As the sheet exits a slot between the platen 180 and guide 300, the sheet 120 is caused to reverse such that the sheet is supported by the platen 180 at a flat portion thereof for printing by the printhead 220.

As shown in FIG. 3, fluid from each of the fluid supply tanks 210 is drawn through the outlet port 310 in the fluid supply tanks and the pipe connectors 230. The fluid follows fluid flow paths 250 in the cartridge housing to the printhead 220. The pipe connectors and flow paths of the cartridge housing supply fluid to fluid channels, replenishing the fluid after each fluid droplet ejection. The fluid at the fluid ejectors must be maintained at a slightly negative pressure, so that the fluid is prevented from dripping from the fluid ejectors, and ensuring that fluid droplets are placed on the recording substrate only when a droplet is ejected by the ejection device. The fluid at the fluid ejectors must also be kept at conditions, including temperature, such that the fluid is kept in a phase state to ensure the fluid does not react with the fluid ejector or pipe connector structure. For example, the temperature of the fluid must be maintained to prevent the fluid from setting and thereby clogging the fluid ejectors or pipe connectors.

In various exemplary embodiments, devices may be located on the printhead 220 or within the printing device 100. For example, an encoder may be located within the printing device 100 to determine the location or position of the printhead 220 with respect to the carriage 110 and/or marking device 100. Devices and systems for determining the operation and alignment of the printhead 220 may also be located on the printhead 220 or within the ink jet printing device 100. Likewise a modifying device that can be used for wiping the printhead 220, e.g., the fluid ejectors 205, or otherwise manipulating the fluid ejectors 205 in order to modify the performance or alignment of the fluid ejectors 205, may also be located on the printhead 220 or within the printing device 100.

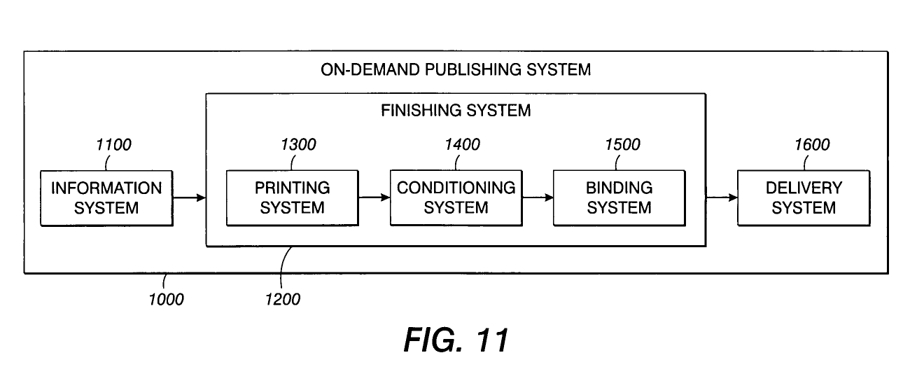

Still other devices may be included along with the fluid printing device 100. For example, when the fluid printing device 100 is part of an on-demand publishing system 1000, as described in FIG. 11, other devices that may be needed to implement the on-demand publishing system 1000, such as, for example, a device for applying pressure to a substrate, maybe included.

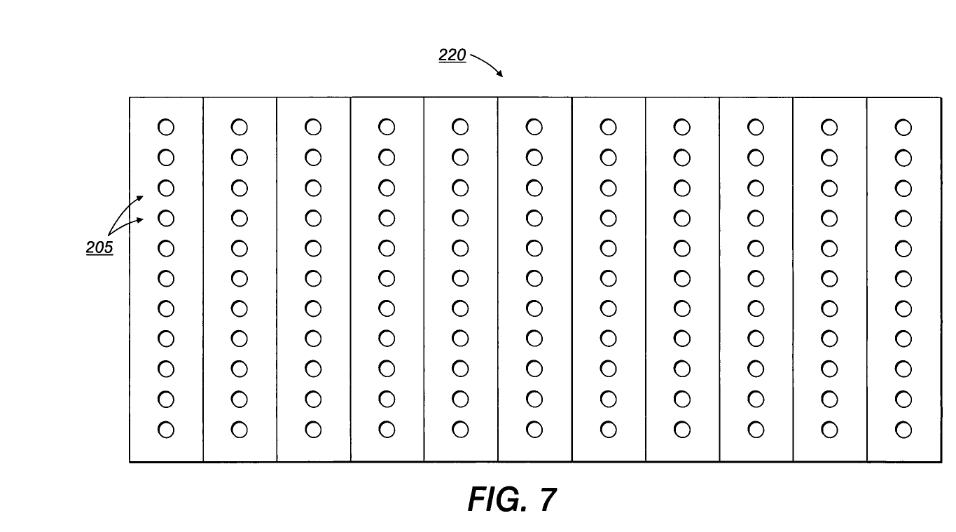

While FIG. 1 and FIG. 2 show a carriage-type fluid printing device 100, whereby the printhead 220 is reciprocated to eject fluid drops on the receiving substrate 120, the array of fluid ejectors 205 may extend across the length of a stationary printhead, as is shown in FIG. 7. This is typically referred to as a page-width array. An exemplary embodiment of a printer 500 incorporating a page-width array is shown in FIG. 8. See, for example, U.S. Pat. No. 5,160,403 to Fisher et al. and U.S. Pat. No. 4,463,359 to Ayata et al., each of which is incorporated herein by reference in its entirety.

Inks used for either continuous stream or drop-on-demand ink jet printing are usually classified as either liquid inks or hot-melt inks. Regardless, of whether liquid ink or hot-melt ink is used in ink jet printing, the ink should have certain properties. For example, generally, image quality is improved if the ink has a consistent density, droplet viscosity and surface tension.

Liquid ink is liquid at room temperature and, generally, is at a temperature close to room temperature when the ink is stored in a printhead prior to being ejected. As discussed above, upon receiving a command to eject ink, jetting energy is applied to the liquid ink so that the liquid ink is ejected from a fluid ejector in the form of an ink droplet to form a dot on a receiving substrate. After the liquid ink is deposited on a receiving substrate, the solvent evaporates leaving the colorant on the receiving substrate. The temperature of the ink ejected does not necessarily have to be significantly raised to be ejected.

A hot-melt solid ink composition, such as a solid ink stick 350, as shown in FIG. 9, is an ink composition. An example of a hot-melt solid ink composition is disclosed in U.S. Pat. No. 6,022,910 to Nishizaki, the disclosure of which is incorporated herein by reference in its entirety. Other disclosures of hot-melt solid ink compositions include U.S. Pat. No. 6,270,561 to Nguyen, U.S. Pat. No. 6,350,889 to Pavlin, U.S. Pat. No. 6,713,529 to Sime, U.S. Pat. No. 6,153,667 to Howald, U.S. Pat. No. 6,106,602 to Ouchi, and U.S. Pat. No. 6,235,098 to Maekawa, the disclosures of which are incorporated herein by reference in their entirety.

Hot-melt solid ink compositions are, generally, solid at room temperature; however, upon heating the hot-melt solid ink composition, the heated hot-melt solid ink liquefies and can be stored, transported, and ejected through the printhead apparatus. After the hot-melt solid ink is liquefied, the liquefied ink is stored at an elevated temperature prior to ejecting the ink. As with liquid ink, upon receiving a command to eject ink, jetting energy is applied to the liquefied ink so that the liquefied fluid is ejected from a fluid ejector in the form of an fluid droplet to form a dot on a receiving substrate. Upon contacting the receiving substrate, which may be at room temperature or pre-heated, the liquefied hot-melt ink will cool and solidify. Generally, all of the components of the hot-melt ink remain where the liquefied ink impacts and solidifies on the receiving substrate.

In the exemplary embodiment shown in FIG. 1, the marking device 100 may generate a high-quality print by jetting ink drops onto a receiving substrate 120. If the marking device 100 uses liquid ink, the ink may be supplied and stored prior to being ejected in a reservoir contained in a liquid fluid cartridge, such as recording heads 200, as shown in FIG. 1, or ink supply tanks 210, as shown in FIG. 4. Incidentally, the ink cartridge may, alternatively, include a reservoir or receptacle for hot melt solid ink. However, generally, if the ink jet printer uses hot-melt ink, a hot-melt solid ink stick 350, such as shown in FIG. 9, is inserted into a receptacle of the ink jet printer.

FIG. 9 illustrates one exemplary embodiment of a perspective view of a hot-melt solid ink stick 350. The exact shape of the hot-melt solid ink stick 350 is not critical, so long as the ink stick 350 is compatible with the ink jet printer device. The shape of the hot-melt solid ink stick 350 is contoured so that the ink stick 350 can be inserted into an opening or receptacle of a reservoir in a printer. The hot-melt solid ink is melted or liquefied, usually by a melt plate or heating resistor located on the surface of the hot-melt solid ink storage reservoir or within adjacent supply channels. The liquefied hot melt ink is then stored in a liquid phase in an additional storage reservoir connected to the supply channels prior to being ejected.

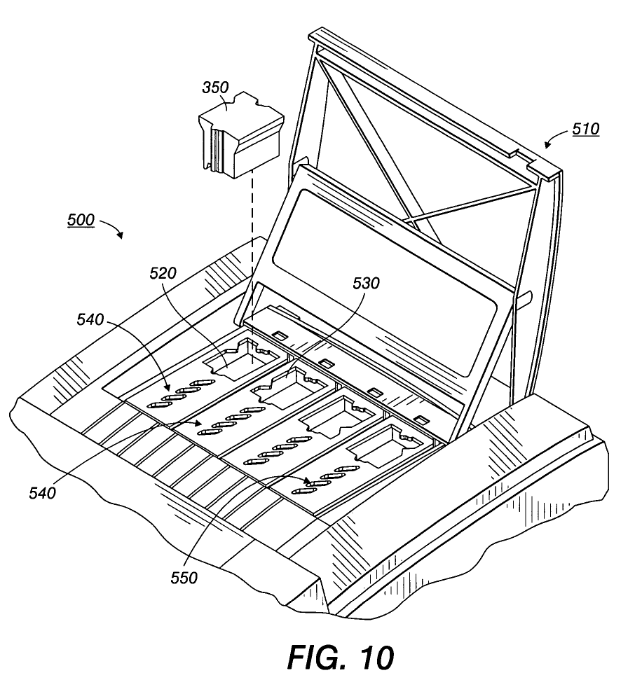

FIG. 8 illustrates a perspective view of one exemplary embodiment of a solid ink jet printer 500. A partial top perspective view of an ink jet printer 500, with an access cover portion 510 open is shown in FIG. 10. In FIG. 10 a hot-melt solid ink stick 350 is positioned to be loaded into an ink stick receptacle opening 520. The exemplary embodiment has four receptacle insertion openings for placing ink sticks 350 in a receptacle. Each receptacle corresponds to a hot-melt solid ink reservoir 530 and is connected to a channel (not shown) beneath each key plate 540. In the exemplary embodiment, each channel has an individual key plate. The individual key plates may have receptacle insertion openings shaped to correspond to a particular color ink stick perimeter shape. Each channel is connected to a liquid ink reservoir (not shown) supplying the printhead and a melt plate (not shown) or heating resistor as known in the art. Apertures 550 in each key plate provide a way to visually assess the ink supply. The channel has a guide (not shown) that guides the ink stick 350 toward the melt plate, whereupon the melt plate melts the portion of the ink stick 350 adjacent to the melt plate until that portion is liquefied. The liquefied ink may then be fed to the liquid ink reservoir located in the printhead.

Printers which use hot-melt ink are designed for a specific hot-melt ink at the printhead and ink jet printing device's operating temperatures. In particular, the properties of the hot-melt ink at the printhead operating temperature can affect the quality of the fluid ejection and the quality of the image created on the receiving substrate. At operating temperatures of, for example, 135° C., hot-melt solid ink is liquefied. Hot-melt solid ink compositions may have a melting range between 50° C. and 200° C. and a melt viscosity between 8 cp and 60 cp, at from 100° C. to 140° C.

An exemplary embodiment replaces hot-melt ink from at least one fluid ejector with hot-melt or UV curable glue. To ensure optimized and consistent fluid ejections, the hot melt glue preferably has similar properties as the hot-melt ink at the printhead operating temperature for a specific printing device. High quality glue jetting, i.e., glue jetting quality similar to the ink jetting quality for a specific printing device, requires that the hot-melt glue have as many similar properties to the hot-melt ink at the printhead operating temperature as possible. Like hot-melt solid ink, for hot-melt solid glue to be used in exemplary embodiments, the hot-melt glue must have a similar viscosity and surface tension at the printhead operating temperature. Preferably, liquefied hot-melt glue has a low viscosity, such as, approximately, 13 cp, or less, and has a surface tension of approximately 15-30 dyne-cm. The printhead operating conditions, such as operating temperature, can be adjusted to provide optimized performance using existing glue compositions, such as, e.g., hot melt or UV curable glue.

As with hot-melt glues, exemplary embodiments replace liquid ink with liquid glue that has similar properties as the liquid ink at the printhead operating temperature for a specific printing device. Liquid glues may include single component glue and multiple-component glue, e.g., two-component glue. With multiple-component glue, at least one component, a resin solution, and a second component, an activator solution, are provided to the ink jet printer.

Two-component glues are used for multiple applications and industries. For example, Seiko provides a two-component glue that is used for fixing crystals to watch cases. Landmark provides a biologically based two-component adhesive, called Gluetiss® aortic glue, for biological applications.

As with hot-melt glue, liquid glue must have similar viscosity and surface tension properties at the printhead operating temperature. For example, generally, the liquid glue must have viscosity, preferably, lower than 13 cp and a surface tension of approximately 15-30 dyne-cm.

Whether hot-melt glue or liquid glue is used, high quality glue jetting requires the glue to have as many similar properties to the liquid ink used in a specific printing device as possible. As such, along with similar surface tension and viscosity properties, the glue should have other similar properties, such as, density. In the case of multiple-component glue, all components of the glue should have similar viscosity and surface tension properties, along with as many other similar properties, to the liquid ink as possible. As discussed above, the printhead operating conditions, such as operating temperature and application voltage, can be adjusted to provide optimized performance using existing glue compositions, such as, e.g., hot melt, UV curable glue, or liquid glue.

As discussed above, if hot-melt glue is used in the printing device, the hot-melt solid glue is supplied and stored in an ink reservoir 550, shown in FIG. 10, just as if hot melt solid ink was supplied to the ink jet printing device. The shape and size of the hot-melt glue should, generally, be identical to the shape and size of the hot-melt ink. For example, if a hot-melt solid glue stick was used in the solid ink jet printer 500 shown in FIG. 8, the shape and size of the hot-melt solid glue stick would be, generally, identical to the shape and size of the hot-melt ink stick 350. If liquid glue is used in the printing device, the liquid glue is supplied and stored in a storage reservoir, such as recording heads 200, shown in FIG. 1, or supply tanks 210, shown in FIG. 2, just as if liquid ink was supplied to the printing device. The apparatus and methods of the printing device use the same methods, apparatuses and systems to eject glue as the printing device would use to eject ink. For example, if the hot-melt ink is melted by a melt plate and ejected by a piezo electric element, the hot-melt glue would be melted by a melt plate and ejected by a piezo electric element.

If multiple component glue, e.g., two-component glue, is used in the printing device, and the printhead has multiple reservoirs for supplying ink to the printhead, then each component of the two-component glue can be supplied to separate reservoirs of the ink jet printing device. If the separate reservoirs supply the printhead with ink via separate supply channels, then each component of the glue is delivered to the printhead by a separate channel connecting the separate reservoir to their corresponding fluid ejectors in the printhead.

For example, in the exemplary embodiment shown in FIG. 4, a printing device has a printhead 220 including four recording head cartridges 200Y, 200M, 200C, 200K dedicated to each of the colors (Y, M, C, K). Four channels 215Y, 215M, 215C, 215K dedicated to each of the four recording head cartridges connect each of the cartridges to a dedicated ink supply stored in four separate ink reservoirs 210Y, 210M, 210C, 210K dedicated to each of the colors. The reservoirs 210 could be part of the recording head cartridge 200 or separate supply tanks, such as supply tanks 210, shown in FIGS. 2 and 3. In the exemplary embodiment shown in FIGS. 2 and 3, a user could replace the reservoirs storing ink with reservoirs storing glue.

If a user desires to eject two-component glue, two reservoirs could be filled with one component of the glue and the other two reservoirs could be filled with the second component of the glue. Thus, for example, reservoirs 210C and 210Y, dedicated to the colors, C and Y, can be replaced with reservoirs dedicated to storing the first component of the glue, while reservoirs 210K and 210M, dedicated to the colors K and M, can be replaced with reservoirs dedicated to the second component of the glue. Channels 215C and 215Y used for supplying colors C and Y to the recording head cartridges 200C and 200Y can be used to supply the first component of the glue to recording head cartridges 200C and 200Y, while the other two channels 215K and 215M, can be used for supplying the second component of the glue to recording head cartridges 200K and 200M.

FIG. 5A shows an exemplary embodiment of a printing device for ejecting a single component glue. As shown in FIG. 5A, one reservoir 210 could be filled with the single component glue. Channel 215 may be used to supply the single component glue to the recording head cartridges 200Y, 200M, 200C and 200K.

FIG. 5B shows an exemplary embodiment of a printing device for ejecting multiple component glue. As shown in FIG. 5B, each component of the multiple component glue, e.g., two component glue, may be stored in individual reservoirs 210G1, 210G2 dedicated to that particular component of the glue. Channels 215G1 and 215G2 may be used to supply each component, respectively, from its respective reservoir, to a common mixing station 225. The mixing station 225 may be used to mix and/or store the multiple components. Common supply channel 215 may be used to supply the mixed glue to the recording head cartridge 200Y, 200M, 200C and 200K of the printhead 220. The glue may then be ejected by the fluid ejectors 205.

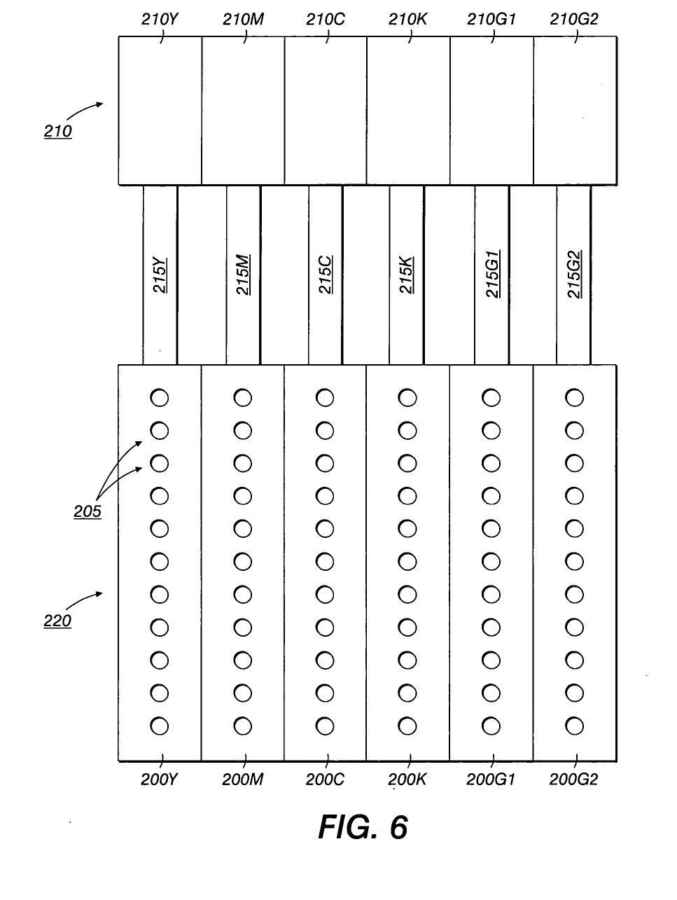

In the exemplary embodiment shown in FIG. 6, printhead 220 includes recording heads dedicated to printing each of the colors, and each component of two-component glue. Recording heads 200Y, 200M, 200C, and 200K, including the corresponding arrays of fluid ejectors 205, are dedicated to marking with each of the colors (Y, M, C, K). Recording heads 200G1 and 200G2, including the corresponding arrays of fluid ejectors 205, are dedicated to marking with each component of two-component glue. The embodiment shown in FIG. 6, operates in a similar manner to the embodiment shown in FIG. 4. Thus, ink supply reservoirs 210Y, 210M, 210C, and 210K store ink dedicated to recording heads 200Y, 200M, 200C, and 200K, respectively. Reservoirs 210G1 and 210G2 are dedicated to storing a first component and a second component of a two-component glue, respectively. The ink from reservoirs 210Y, 210M, 210C, and 210K, is supplied via supply channels 215Y, 215M, 215C, and 215K, to recording heads 200Y, 200M, 200C, and 200K. Each component of the glue is supplied via separate glue component channels 215G1 and 215G2 to the ejector arrays of 200G1 and 200G2, respectively. In the case of single component glue, only one reservoir 210G1, supply channel 215G1, and ejector array 200G1 may be sufficient. Because the embodiment disclosed in FIG. 6 stores and supplies ink and glue to a printhead, the embodiment provides the advantage of a printhead 220 capable of printing both ink and glue during a single operation. As discussed above, the above disclosed concept can be used for liquid, hot-melt, and UV curable glues. As discussed above, because the glue replaces the ink in the printer technology, the advantages of the printer technology can be extended to glue ejecting (e.g., binding system) technology. For example, exemplary embodiments provide, generally, precise positioning, high metering and accurate delivery of a few pico-liter size glue drop to an approximately, 100 pico-liter size glue drop. Preferably, exemplary embodiments provide, generally, precise positioning, high metering and accurate delivery of a glue drop between 10 and 40 pico-liters in size.

While the embodiments shown in FIGS. 4-6 show ejectors dedicated to a specific color or a specific component of glue vertically aligned, the ejectors could, alternatively, be horizontally offset to prevent the mixing of glue with the colored inks. Other arrangements and alignments of the fluid ejectors are also possible.

Depending on the properties of the two-component glue, when two-component glue is used, it is may be desirable to eject drops for the first component and then, subsequently, eject drops for the second component. With multiple-component glue, generally, all components of the glue are required to be mixed for the full properties of the glue to be obtained. Accordingly, when two-component glue is used, the second component of the glue is ejected such that the second component is registered or located on top of or at least in close proximity to the first component of the glue previously ejected. The components of the glue are mixed by registering the second component of the glue on the first component of the glue, or by placing the second component of the glue as close as possible to the first component. As such, the printhead can be controlled to eject each component in a timely fashion to ensure that proper mixing can occur prior to binding, cooling, solidifying, or evaporating. Applying pressure to the second component of the glue after it has been ejected onto the substrate, such as by applying a second substrate on top of the second component of the glue, can also be used to encourage mixing or paper binding of the two-components.

Other exemplary embodiments can be directed to three-dimensional printing. For example, the ink jet printer could be used to make a three-dimensional object by 1) ejecting glue or a liquid material and a binder on a substrate in a pattern; 2) allowing the ejected glue or liquid material and binder to cool and solidify; and 3) repeating steps 1 and 2 until a desired object has been created.

Still other exemplary embodiments can be directed to the assembly of intricate parts. For example, as discussed above, exemplary embodiments provide, precise positioning and high metering of pico-liter size glue drops on a substrate. As such, exemplary embodiments may be directed to the precise positioning and high metering of glue drops on small parts or areas of parts. Other systems and apparatus can then be used in conjunction with the ink jet printer to assemble the intricate parts prior to the glue cooling and solidifying.

Furthermore, in exemplary embodiments, the binding system including a fluid ejecting ink jet printer can be used as part of an on-demand publishing system. Binder systems include any system that places glue on a substrate, and, by using the glue placed on the substrate, is capable of binding that substrate to itself or another substrate. Binding systems can include packaging systems, customized mail systems, art and/or decorating systems (e.g., card creation and delivery systems), intricate parts assembly systems, etc. For simplicity and clarification, the operating principles and design factors of various exemplary embodiments of the systems, methods, and apparatus are explained, in part, with reference to an exemplary embodiment of an on-demand publishing system 1000, as shown in FIG. 11. The basic explanation of the operation of the on-demand publishing system 1000 is applicable to the understanding of any printing system or binding system. As such, although the systems, methods and apparatus are described in conjunction with the on-demand publishing system 1000, the systems, methods and apparatus may be used with any other known or later-developed printing system or binding system.

FIG. 11 discloses that the binding system can be part of an on-demand publishing system 1000. In FIG. 11, the on-demand publishing system 1000 may include an information system 1100, a finishing system 1200, and a delivery system 1600. The systems may be connected mechanically and electronically.

The information system 1100 implements the on-demand publishing system 1000 and controls the operation of the system. The information system 1100 can implement the systems illustrated in FIG. 11-18 along with other systems necessary to carry-out the systems, methods and processes necessary to implement the on-demand publishing system 1000 discussed herein.

As shown in FIG. 11, upon the information system 1100 receiving information, such as a command to print and bind multiple substrates, e.g., a book or magazine, the information system 1100 sends printing, binding, conditioning and delivery information to the finishing system 1200. The information received and sent by the information system 1100 may include information such as, for example, the images to be printed, number of pages to be printed, and the type of substrate, e.g., the type of paper, or cover, to be printed. The information system may print a single copy or multiple copies of any one of a multiplicity of books stored in an information system. After receiving the printing, binding, conditioning and delivery information, the finishing system 1200 uses this information to produce a book or magazine.

Generally, as shown in FIG. 11, the finishing system 1200 includes a printing system 1300, conditioning system 1400, and binding system 1500. The printing system 1300 prints the book pages and cover. The conditioning system 1400 prepares the book pages and cover for binding by, for example, rotating or trimming the pages. The binding system 1500 binds the book. The delivery system 1600 stores the book and/or delivers the book to a customer. These systems are discussed in detail below.

FIG. 12 illustrates an exemplary embodiment of a finishing system 1200. In the exemplary embodiment shown in FIG. 12 the printing system 1300 employs one or more page printers 1310 and a cover printer 1340 to print a book selected to be printed. The finishing system's controller (not shown) transmits the print information, such as the cover print data and the page print data, to the cover printer 1340 and the page printer 1310. Upon receiving this information, the printers print the book's cover 1390 and pages 1320 and deposits the cover and pages on the printers' respective horizontal beds 1315 and 1345, respectively, as the cover and pages are output from the respective printers 1310 and 1345. The printers maybe similar to Phaser 300X printers available from Xerox Corporation.

Alternatively, in another embodiment, the printing system 1300 may include a single printer for printing both the book's cover and pages. In this embodiment, the cover medium and page medium may be stored in separate printer medium drawers or trays.

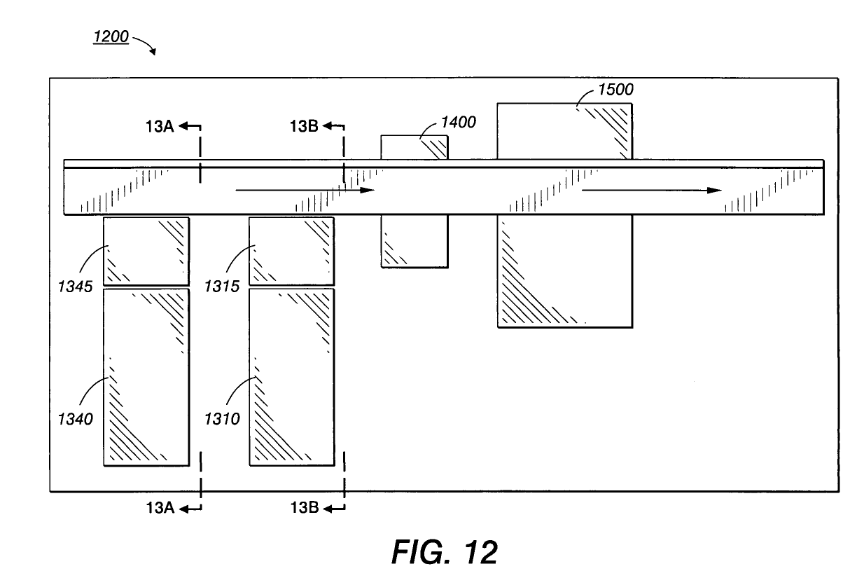

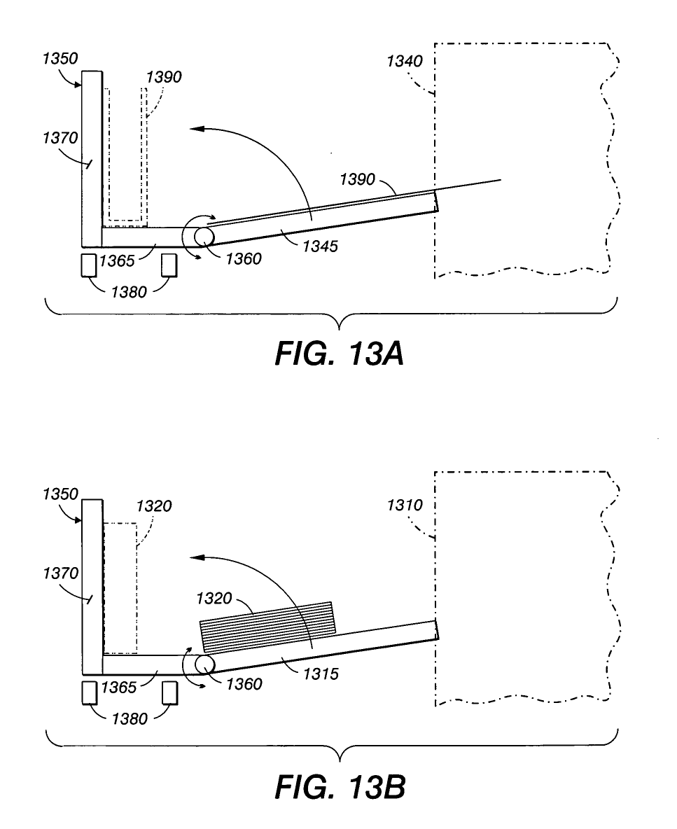

After the cover 1390 has been printed by cover printer 1340 and deposited on the cover's horizontal bed 1345. The cover is rotated to a generally vertical position, as shown in phantom in FIG. 13A, onto a transport conveyor 1350. The transport conveyor includes a base part 1365. Bed 1345 is part of the transport conveyor 1350 and is pivotally movable about a pivot point 1360 from a generally horizontal position (as shown in solid lines in FIG. 13A), in which the bed 1345 receives pages from the page printer 1340, to a generally vertical position (as shown in phantom lines in FIG. 13A) in which the cover is disposed in a generally vertical position on transport conveyor 1350. Base part 1365 is also pivotally movable about pivot point 1360. Base part 1365 and bed 1345 may be pivoted as necessary to rotate the cover to a desired position. Bed 1345 is pivotally connected to and is movable with a carriage part 1370 of the transport conveyor 1350. The carriage part 1370 is movable along a track 1380. The carriage part 1350 and track 1380 transport the cover held thereon to the conditioning system 1400.

Similar to the conveyor transportation method discussed above with regard to the cover, after the book's pages 1320 have been printed by page printer 1310 and deposited on the horizontal bed 1315, the bed 1315 and pages 1320 are rotated to a generally vertical position, as shown in phantom in FIG. 13B, onto a transport conveyor 1350. Transport conveyor 1350 includes a base part 1365. Bed 1315 is part of the transport conveyor 1350 and is pivotally movable about a pivot point 1360 from a generally horizontal position (as shown in solid lines in FIG. 13B) in which the bed 1315 receives pages from the page printer 1310 to a generally vertical position (as shown in phantom lines in FIG. 13B) in which the pages are disposed in a generally vertical position on transport conveyor 1350. Base part 1365 is also pivotally movable about pivot point 1360. Base part 1365 and bed 1345 may be pivoted as necessary to rotate the book pages to a desired position. Bed 1315 is pivotally connected to and is movable with a carriage part 1370 of the transport conveyor 1350. The carriage part 1370 is movable along a track 1380. Carriage part 1370 has a vertical support against which pages 1320 are held as the pages are transported. The carriage part 1370 and track 1380 transport the pages held within the carriage part 1370 from the printer 1310 to the conditioning system 1400, and from the conditioning system 1400 to the binding system 1500.

After printing operations, the conditioning system 1400 prepares the book's pages and cover for subsequent operations, such as binding. For example, the conditioning system 1400 may collate, trim, stack, jog, score, rotate, and position the pages and/or cover such that the pages and cover are prepared for binding. After the conditioning system has positioned and prepared the cover 1390 and pages 1320 for binding, the cover 1390 and pages 1320 are forwarded to the binding system 1500.

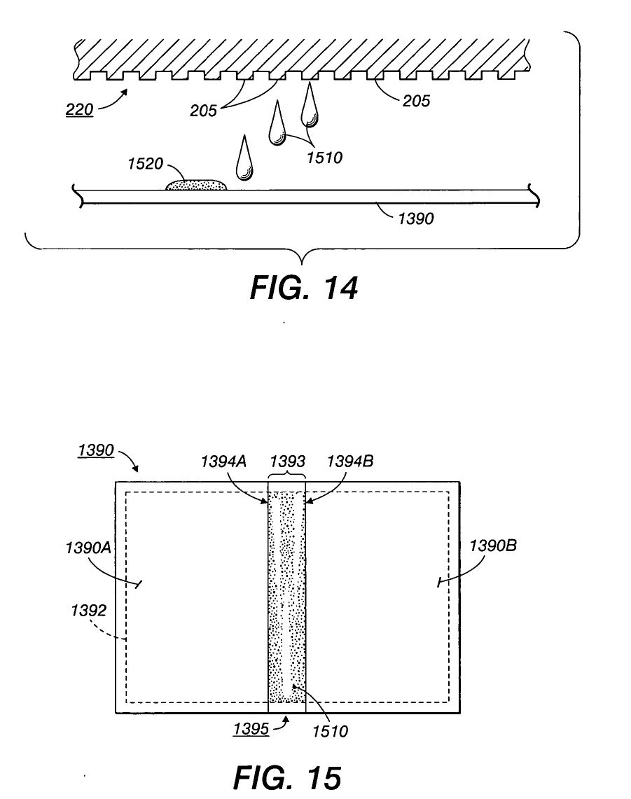

As discussed above, the binding system 1500 places glue 1510 on a receiving substrate by way of a marker using ink jet printer technology. The marker may be a model Phaser 300X printer available from Xerox Corporation. FIG. 14 is an exemplary embodiment of a cross-sectional view of a fluid ejector system ejecting glue onto a receiving substrate. As illustrated in the exemplary embodiment shown in FIG. 14, fluid ejectors 205 located on printhead 220 eject glue drops 1510 towards the cover 1390. The fluid ejectors can precisely deposit glue 1510 in a predetermined pattern and/or location 1520 on the cover.

FIG. 15 illustrates an exemplary embodiment of a plan view of an inner face of a cover 1390. Broken lines 1392 illustrate the boundary of pages 1320 once they are inserted into the book cover 1390. Cover 1390 has an inner front cover 1390A, an inner back cover 1390B, and a center portion 1393 bounded by score lines 1394A and 1394B. The area bounded by score lines 1394A, 1394B and broken lines 1392 represent the glue deposit location 1520. The binding system 1500 ejects glue 1510 from a marker onto the center portion 1393 of the cover, using systems and methods described previously in the application.

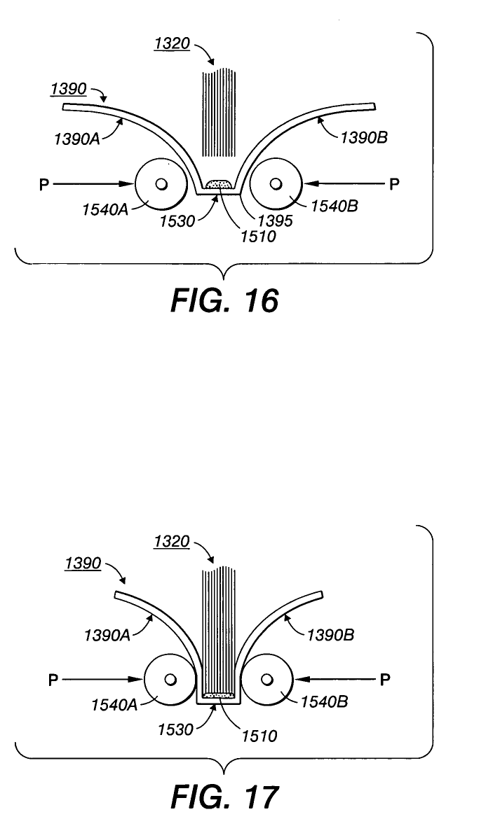

FIGS. 16 and 17 are illustrative embodiments of an apparatus and method to bind the book pages to the cover. In the exemplary embodiment shown in FIG. 16, the center portion 1393 of the cover 1390 has a deposit of glue 1510 at a location 1520. To complete binding, the book's pages 1320 force the cover 1390 downward such that the book's pages and the cover contact the glue 1510. The book's pages and cover 1390 are also forced between a pair of pressing rollers 1540A, 1540B. The pressure on the cover 1390 created by the pages 1320 pressing the cover portion 1390 downward forms a pocket 1530 in the cover 1390. As shown in FIG. 17, the glue 1510 is placed in contact with the book pages 1320 and the cover 1390 within the pocket 1530.

The pressure created by pressing the glue between the pages and the cover within the pocket may be adequate to bind the pages to the cover. However, in the exemplary embodiments shown in FIGS. 16 and 17, pressing rollers 1520A, 1520B provide additional compression force P to further compress the book pages to the cover. Moreover, while the embodiments shown in FIG. 16 and FIG. 17 show rollers providing horizontal forces to the book cover's pocket, other embodiments may have a roller or other device providing vertical forces to the book cover's pocket. Other methods may also be applied to compress and bind the book pages, glue, and cover. For example, a clamp, ultrasonic horn, or stamper may be used to bind the book's pages to the cover.

As discussed above, in the exemplary embodiment shown in FIG. 12, the finishing system 1200 has a separate printer for marking the pages and cover with ink from the printer marking the pages and cover with glue. However, in other exemplary embodiments, the printer used in the binding system 1500 may be the same printer used in the printing system 1300.

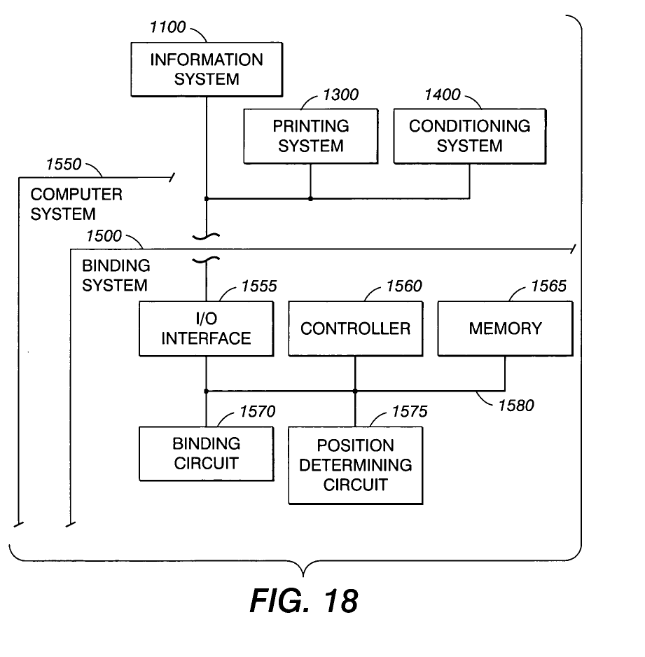

As shown in FIG. 11, the information system 1100 of the on-demand publishing system 1000 can be used to control the on-demand publishing system 1000, as well as sub-routines for controlling the finishing system 1200 and delivery system 1600. Moreover, the information system 1100 can be used to control further sub-routines, such as routines for controlling the printing system 1300, conditioning system 1400, and binding system 1500. However, for simplicity and clarification, the operating principles and design factors of various exemplary embodiments of the systems, methods and apparatus are explained, in part, with reference to an exemplary embodiment of a control system for controlling a binding system 1500, as shown in FIG. 18. The basic explanation of the operation of the control system for controlling the binding system 1500 is applicable to the understanding of any control system, such as a control system for an on-demand publishing system 1000. As such, although the systems, methods and apparatus are described in conjunction with the control system for controlling a binding system 1500, the systems, methods and apparatus can be used to control any other known or later-developed control system.

FIG. 18 shows one exemplary embodiment of a control system for controlling a binding system 1500. This system maybe housed in a computer 1550. As shown in FIG. 18, the binding system 1500 includes an input/output interface (I/O) 1555, a controller 1560, a memory 1565, a binding circuit, routine or application 1570, and a position determining circuit, routine or application 1575 interconnected by one or more control and/or data busses and/or application programming interfaces 1580.

The controller 1560 controls the information sent and received by the I/O interface 1555. I/O interface 1555 may receive data signals from and transmit data signals to outside data devices. For example, I/O interface 1555 can receive data signals, such as an image signal, from an outside controller, such as from a controller of an information system 1100 of an on-demand publishing system 1000, or send data signals to outside systems, such as a conditioning system 1400 or a printing system 1300. The controller 1560 can use the information received from the outside sources, to control binding operations. For example, the controller 1560 can be used to control glue ejection, timing and placement.

As shown in FIG. 18, the control system for controlling a binding system 1500 is, in various exemplary embodiments, implemented on a programmed general purpose computer 1550. However, the control system can also be implemented on a special purpose computer, a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device, capable of implementing a finite state machine that is in turn capable of implementing the circuits, routines, or applications shown in FIG. 18, can be used to implement the control system.

In FIG. 18, alterable portions of the memory 1565 are, in various exemplary embodiments, implemented using static or dynamic RAM. However, the memory 1565 can also be implemented using a floppy disk and disk drive, a writable optical disk and disk drive, a hard drive, flash memory or the like. In FIG. 18, the generally static portions of the memory 1565 are, in various exemplary embodiments, implemented using ROM. However, the static portions can also be implemented using other non-volatile memory, such as PROM, EPROM, EEPROM, an optical ROM disk, such as a CD-ROM or DVD ROM, and disk drive, flash memory or other alterable memory, as indicated above, or the like.

Further, it should be appreciated that the programming interfaces 1580 connecting the memory 1565 to the computer 1550 can be a wired or wireless link to a network. The network can be a local area network, a wide area network, an intranet, the Internet, or any other distributed processing and storage network.

The control system may not only be run to bind automatically, it may also be run manually. If the system is manually operated, the user inputs a request to start the system. If the system is set to automatically run, the system is set to run by the controller 1560.

The particular form of the circuits, routines, applications, objects or managers shown in FIG. 18 will take is a design choice and will be obvious and predictable to those skilled in the art. It should be appreciated that the circuits, routines, applications, objects or managers shown in FIG. 18 do not need to be of the same design. For example, the binding circuit 1570 could be broken into other circuits, routines or applications for separately performing fluid ejection and applying pressure to the substrates.

It is evident that many alternatives, modifications, and variations, of the exemplary embodiments disclosed herein will be apparent to those skilled in the art. For instance, while one skilled in the art of printing will apply the systems, methods and apparatus to binding with glue or printing with ink, it is noted that the systems, methods and apparatus disclosed herein apply to fluids other than glue and ink. Likewise, while exemplary embodiments were described above with respect to fluid ejectors of an ink jet printer, it is noted that the systems, methods and apparatus disclosed herein apply to micro-mechanical and micro-electro-mechanical dispensing mechanisms (MEMS) ejecting systems. Accordingly, the exemplary embodiments as set forth above are intended to be illustrative and not limiting. Various changes may be made without departing from the spirit and scope of the methods, systems and apparatus described herein.

What is claimed is:

1. A binding system, comprising:
a fluid ejection system including an array of fluid ejectors and at least one fluid supply reservoir connected by a fluid supply channel;
a glue composition that has generally the same viscosity and surface tension as a marking fluid other than glue at the fluid ejector operating temperature;
wherein the fluid ejectors, fluid supply channel and the fluid supply reservoir are compatible for use with both the glue and the marking fluid other than glue; and the fluid ejectors have a defined resolution of at least 75 dots per inch and eject the glue with a precisely controlled pattern.

2. The binding system of claim 1, wherein the fluid ejection system further comprises:
a second array of fluid ejectors connected to at least one second fluid supply reservoir by a second fluid supply channel, wherein the second array of fluid ejectors eject a marking fluid.

3. The binding system of claim 1 wherein, the fluid ejection system is capable of delivering a glue drop in a range of 3 to 40 pico-liters in size.

4. The binding system of claim 1, wherein the glue is liquid at room temperature as well as at an elevated temperature.

5. The binding system of claim 1, wherein the glue is liquid at and near the fluid ejector operating temperature.

6. The binding system of claim 5, wherein the fluid ejector operating temperature range is between 80° C. and 150° C.

7. The binding system of claim 1, wherein the glue composition is a two-component glue, the first component being ejected from a first array of fluid ejectors and the second component being ejected from a second, different array of fluid ejectors proximate to the ejected first component to form a deposited glue on a substrate.

8. The binding system of claim 1, further comprising a mixing station and a common fluid supply channel wherein the glue is a multiple component glue and each component of the multiple component glue is mixed in the mixing station.

9. The binding system of claim 1, wherein a fluid reservoir, a fluid channel and an array of fluid ejectors are added to the binding system.

10. An on-demand publishing system comprising the binding system of claim 1, wherein a first array of fluid ejectors are dedicated to ejecting ink received from an ink reservoir and a second array of fluid ejectors are dedicated to ejecting the glue composition.

11. A method of using the binding system of claim 1, comprising:
inserting a liquid glue supply cartridge or hot-melt solid glue supply stick in at least one of the fluid supply reservoirs; and
ejecting glue from at least one array of fluid ejectors in a precisely controlled pattern.

12. The method of using the binding system of claim 1 1, further comprising:
inserting a marking fluid supply cartridge in another fluid supply reservoir; and
ejecting the marking fluid.

13. The binding system of claim 1, wherein the glue composition has a viscosity between 3 cp and 60 cp and a surface tension between 15-30 dyne-cm.

14. The binding system of claim 1, wherein the glue composition includes a first component ejected from a first array of fluid ejectors and a second component ejected from a second array of fluid ejectors, the two components when mixed form a composition with an adhesive property.

15. The binding system of claim 14, wherein both the first and the second components are liquid at room and the system's operating temperature.

16. The binding system of claim 1, wherein the glue composition is liquid at the system's operating temperature and not liquid at room temperature.

17. The binding system of claim 1, wherein the glue composition comprises multiple components and at least one component is liquid at the operating temperature but not at room temperature.

18. The binding system of claim 17, wherein at least one component is a paste at room temperature.

19. A method of binding using the binding system of claim 1, comprising:
ejecting a first component of the glue composition on a substrate using a first array of fluid ejectors;
subsequently, ejecting a second component of the glue composition on a substrate using a second array of fluid ejectors; and
contacting the first component with the second component such that mixing between the first component and the second component can occur to form a glue composition with an adhesive property that is precisely located on the substrates.

20. A method of binding using a multicolor printer having an array of fluid ejectors for each color and a fluid reservoir for each color, comprising:
filling at least one of the fluid reservoirs with a glue composition having a viscosity, surface tension and density that is compatible with an ink used in the printer at room temperature and the printer's operating temperature; and
ejecting the glue composition onto a substrate in a precisely controlled manner.
